(19) United States
(12) Patent Application Publication
(10) Pub. No.: US 2001/0037724 A1
(43) Pub. Date: Nov. 8, 2001

(54) System for controlling hydraulic actuator

(76) Inventors: Mark S. Schumacher, Minneapolis, MN (US); Terrance F. Krouth, Eden Prairie, MN (US); David E. Wiklund, Eden Prairie, MN (US)

Correspondence Address: Christopher R. Christenson, WESTMAN CHAMPLIN & KELLY, P. A., Suite 1600 - International Centre, 900 Second Avenue South, Minneapolis, MN, 55402-3319, US

(21) Appl. No.: 09/801,259

(22) Filed: Mar. 7, 2001

Related U.S. Application Data
(60) Provisional application No. 60/218,329, filed on Jul. 14, 2000.
(60) Provisional application No. 60/187,849, filed on Mar. 8, 2000.

(51) Int. Cl. F15B 9/03

(52) U.S. Cl. 91/363 R

(57) ABSTRACT

A system and method for controlling at least one hydraulic actuator of a hydraulic system includes a flow rate measurement of a hydraulic fluid flow traveling into and out of a cavity of the hydraulic actuator. The flow rate is used to calculate piston information corresponding to a position, velocity, acceleration, and/or direction of movement of a piston of the hydraulic actuator. The piston information can then be provided to an output device to aid in the control of the hydraulic actuator. Alternatively, the piston information can be compared to a reference signal relating to a desired position, velocity, acceleration, and/or direction of movement of the piston to produce a control signal, which can be used to adjust the hydraulic fluid flow and provide the desired actuation of the piston.

### CROSS-REFERENCE TO RELATED APPLICATION

The present invention claims the benefit of U.S. patent application Ser. No. 09/521,132, entitled “PISTON POSITION MEASURING DEVICE,” filed Mar. 8, 2000, and U.S. Provisional Application No. 60/218,329, entitled “HYDRAULIC VALVE BODY WITH DIFFERENTIAL PRESSURE FLOW MEASUREMENT,” filed Jul. 14, 2000. In addition, the present invention claims the benefit of U.S. patent application Ser. No. 09/521,537, entitled “BI-DIRECTIONAL DIFFERENTIAL PRESSURE FLOW SENSOR,” filed Mar. 8, 2000, and U.S. Provisional Application No. 60/187,849, entitled “SYSTEM FOR CONTROLLING MULTIPLE HYDRAULIC CYLINDERS,” filed Mar. 8, 2000.

### BACKGROUND OF THE INVENTION

The present invention relates to hydraulic systems of the type used to actuate machinery. More specifically, the present invention relates to controlling such systems through measurement of position, velocity, acceleration, and/or direction of movement of hydraulic actuator pistons of hydraulic actuators.

Hydraulic systems are used in a wide variety of industries ranging from road construction to processing plants. These systems are generally formed of hydraulic control valves and hydraulic actuators. Typical hydraulic actuators include a hydraulic cylinder containing a piston. A rod is attached to the piston at one end and to an object, which is to be manipulated by the hydraulic actuator, at the other end. The hydraulic system controls at least one hydraulic control valve to direct a hydraulic fluid flow into and out of at least one cavity of a hydraulic actuator that is defined by the piston and the hydraulic cylinder. The hydraulic fluid flow causes a change in the position of the piston within the hydraulic cylinder and produces the desired actuation of the object.

The control of the hydraulic actuators is often performed by an operator who visually inspects the position of the hydraulic actuators. Such a physical inspection is relatively crude and prone to a great deal of inaccuracy. For many applications, it would be useful to know the position, velocity and/or acceleration of the piston. By these variables, a control system could be established to more precisely control the location or orientation, velocity and acceleration of the objects being actuated by the hydraulic actuators. For example, a blade of a road grading machine could be repeatedly positioned as desired resulting in more precise grading.

There is a need for improved methods and devices which are capable of achieving accurate, repeatable, and reliable hydraulic actuator piston position measurement and control.

### SUMMARY OF THE INVENTION

The present invention is directed to a hydraulic control system for controlling at least one hydraulic actuator. The hydraulic control system includes a fluid flow sensor, a controller, and a communication link. The flow sensor is positioned in line with a hydraulic fluid flow and is adapted to measure a flow rate of the hydraulic fluid flow traveling into and out of a cavity of the hydraulic actuator. The flow sensor includes a sensor signal that is related to a position, velocity, acceleration, and/or a direction of movement of a piston contained in a hydraulic cylinder of the hydraulic actuator. A hydraulic control valve controls the hydraulic fluid flow traveling into the cavity, the volume of which is directly related to the position of the piston. The controller is adapted to receive the sensor signal from the flow sensor through the communication link.

In one aspect of the invention, the controller provides a piston information output relating to various types of piston information. The piston information generally corresponds to the position, velocity, acceleration, and/or the direction of movement of the piston. The piston information output can be provided to a human-machine interface to aid in the control of the piston and, thus, the object being actuated by the actuator.

In another aspect of the present invention, the controller produces a control signal based upon a comparison of the sensor signal to a reference signal. The reference signal generally relates to a desired position, velocity, acceleration, and/or direction of movement of the piston. The control signal is used to control the hydraulic fluid flow such that the piston is adjusted toward the desired position, velocity, acceleration, and/or direction of movement.

The present invention is also directed toward a method of controlling at least one piston of a hydraulic actuator. Here, a flow rate of a hydraulic fluid flow traveling into and out of a cavity of the hydraulic actuator is measured. Piston information relating to at least one of a position, a velocity, an acceleration, and a direction of movement of the piston is then calculated based upon the measured flow rate. Next, a reference signal is provided, which relates to at least one of a desired position, velocity, acceleration, and/or a direction of movement of the piston. Finally, the hydraulic fluid flow is adjusted based upon a comparison between the piston information and the reference signal. In this manner, the piston, whose movement is directly related to the hydraulic fluid flow, can be adjusted toward the desired position, velocity, acceleration, and/or direction of movement that is desired.

### BRIEF DESCRIPTION OF THE DRAWINGS

FIG. 1 is a simplified diagram of an example of a hydraulic system, in accordance with the prior art, to which the present invention can be applied.

FIG. 2 is a simplified diagram of a hydraulic control system in accordance with an embodiment of the invention.

FIG. 3 is a flowchart illustrating a method of controlling at least one hydraulic actuator in accordance with an embodiment of the invention.

### DETAILED DESCRIPTION OF THE PREFERRED EMBODIMENTS

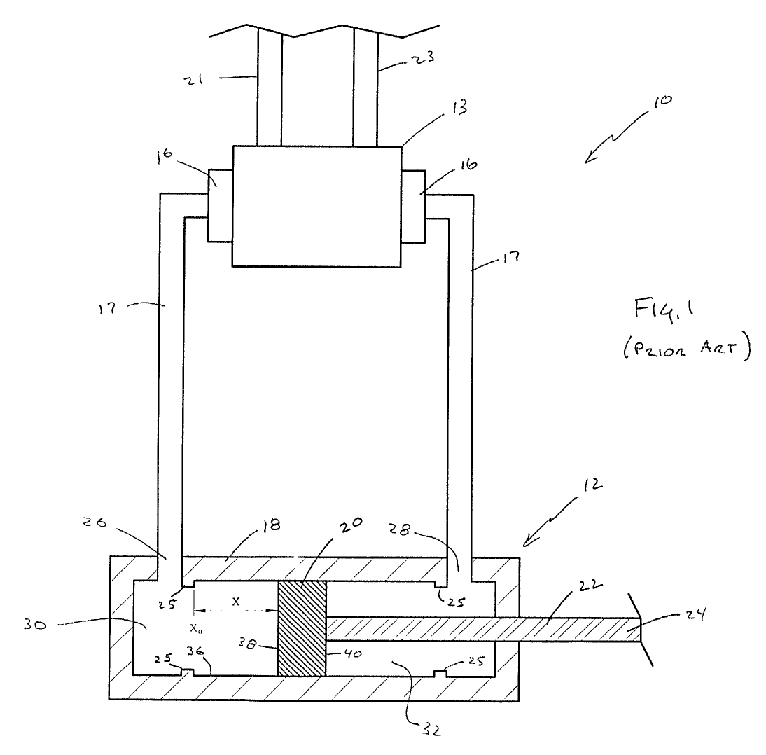

The present invention provides a method and system for controlling hydraulic actuators that are used in a hydraulic system to actuate components of a machine. FIG. 1 shows a simplified diagram of an example of a hydraulic system 10, with which embodiments of the present invention can be used. Hydraulic system 10 generally includes hydraulic actuator 12, hydraulic control valve 13, and high and low pressurized sources of provided through hydraulic lines 21 and 23. Hydraulic control valve 13 is generally adapted to control a flow of hydraulic fluid into and out of cavities of hydraulic actuator 12, which are fluidically coupled to ports 16 through fluid flow conduit 17. Alternatively, hydraulic control valve 13 could be configured to control hydraulic fluid flows into and out of multiple hydraulic actuators 12. Hydraulic control valve 13 can be, for example, a spool valve, or any other type of valve that is suitable for use in a hydraulic system.

The depicted hydraulic actuator 12 is intended to be one example of a hydraulic actuator, with which embodiments of the present invention may be used. Hydraulic actuator 12 generally includes hydraulic cylinder 18, piston 20, and rod 22. Piston 20 is attached to rod 22 and is slidably contained within hydraulic cylinder 18. Rod 22 is further attached to an object or component (not shown) of a machine at end 24 for actuation by hydraulic actuator 12. Piston stops 25 can be used to limit the range of motion of piston 20 within hydraulic cylinder 18. Hydraulic actuator 12 also includes first and second ports 26 and 28, through which a hydraulic fluid flow travels into and out of first and second cavities 30 and 32, respectively, through fluid flow conduit 17. First cavity 30 is defined by interior wall 36 of hydraulic cylinder 18 and surface 38 of piston 20. Second cavity 32 is defined by interior wall 36 of hydraulic cylinder 18 and surface 40 of piston 20.

First and second cavities 30 and 32 of hydraulic actuator 12 are completely filled with a substantially incompressible hydraulic fluid. As a result, the position of piston 20, relative to hydraulic cylinder 18, is directly related to the volume of either first cavity 30 or second cavity 32 and, thus, the volume of hydraulic fluid contained in first cavity 30 or second cavity 32. In operation, as pressurized hydraulic fluid is forced into first cavity 30, piston 20 is forced to slide to the right thereby decreasing the volume of second cavity 32 and causing hydraulic fluid to flow out of second cavity 32 though second port 28. Similarly, as pressurized hydraulic fluid is pumped into second cavity 32, piston 20 is forced to slide to the left thereby decreasing the volume of first cavity 30 and causing hydraulic fluid to flow out of first cavity 30 through first port 26. Those skilled in the art will understand that the present invention can be used with many different types of hydraulic actuators 12 having configurations that differ from the provided example and yet have at least a first cavity whose volume is directly related to the position of piston 20.

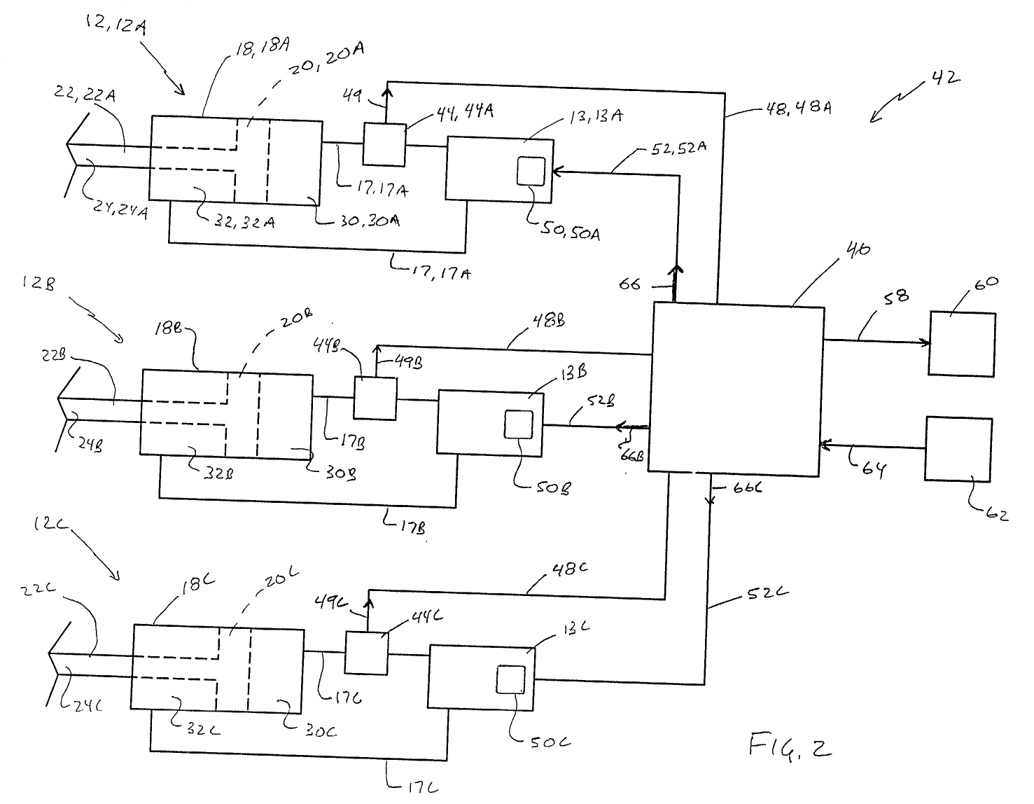

FIG. 2 shows a hydraulic control system 42, in accordance with the present invention, for controlling the actuation of at least one hydraulic actuator 12. Hydraulic control system 42 generally includes multiple hydraulic actuators 12, shown as hydraulic actuators 12A, 12B and 12C. Although only three hydraulic actuators 12A-C are shown, it should be understood that hydraulic actuators 12 can be added to or subtracted from the depicted hydraulic control system 42 as desired. Each of the sample hydraulic actuators 12A-C contain the same or similar components as hydraulic actuator 12 (FIG. 1), which are designated with the corresponding letter A, B or C, respectively. To simplify the discussion of hydraulic control system 42, the invention will be described with reference to a single hydraulic actuator 12, although the description can be applied to hydraulic actuators 12A-C by inserting the corresponding letter designations.

Hydraulic control system 42 generally includes at least one fluid flow sensor 44, a controller 46, and a communication link 48, through which information can be communicated between flow sensor 44 and controller 46. In one embodiment of the invention, fluid flow sensor 44 is adapted to produce a sensor signal relating to a flow rate Q_{V1} of the hydraulic fluid flow traveling into and out of first cavity 30 of hydraulic actuator 12. The sensor signal can be used to calculate piston information relating to the position, velocity, acceleration and/or direction of movement of piston 20 relative to hydraulic cylinder 18.

Referring again to FIG. 1, the methods used to calculate the piston information based upon a measured flow rate Q_{V1} will be discussed. A position x of piston 20 is directly related to the volume V₁ of hydraulic fluid contained in first cavity 30. This relationship is shown in the following equation:

$$x = \frac{{V}_{1} - {V}_{0}}{{A}_{1}} \qquad Eq . 1$$

where A₁ is the cross-sectional area of first cavity 30 and V₀ is the volume of first cavity 30 when piston 20 is in reference position (x₀) from which the position x is measured.

As the hydraulic fluid is pumped into or out of first cavity 30, the position x of piston 20 will change. For a given reference or initial position x₀ of piston 20, a new position x can be determined by calculating the change in volume ΔV₁ of first cavity 30 over a period of time t₀ to t₁ in accordance with the following equations:

$$Δ {V}_{1} = {\int }_{t0}^{t1} {Q}_{v1} \\ x = {x}_{0} + \frac{Δ {V}_{1}}{{A}_{1}} = {x}_{0} + \frac{1}{{A}_{1}} {\int }_{t0}^{t1} {Q}_{v1} \qquad Eq . 3$$

where Qᵥ₁ is the volumetric flow rate of the hydraulic fluid flow into or out of first cavity 30. Although, the reference position x₀ for the above example is shown as being set at the left most stops 25, other reference positions are possible as well. As a result, the position x of piston 20 can be determined using the flow rate Qᵥ₁, which can be measured using flow sensor 44 (FIG. 2).

The velocity at which the position x of piston 20 changes is directly related to the volumetric flow rate Qᵥ₁ of the hydraulic fluid flow into or out of first cavity 30. The velocity υ of piston 20 can be calculated by taking the derivative of Eq. 3, which is shown in the following equation:

$$v = \frac{ⅆ x}{ⅆ t} = \frac{{Q}_{v1}}{{A}_{1}} \qquad Eq . 4$$

The acceleration of piston 20 is directly related to the rate of change of the flow rate Qᵥ₁, as shown in Eq. 5 below. Accordingly, by measuring the flow rate Qᵥ₁ flowing into and out of first cavity 30, the position, velocity, and acceleration of piston 20 can be calculated.

$$a = \frac{ⅆ v}{ⅆ t} = \frac{ⅆ}{ⅆ t} ( \frac{ⅆ x}{ⅆ t} ) = \frac{1}{{A}_{1}} ( \frac{ⅆ {Q}_{v1}}{ⅆ t} ) \qquad Eq . 5$$

Finally, the direction of movement of piston 20 can be determined by the direction in which the hydraulic fluid flow is traveling. Here, a positive flow rate Q_{V1} can be indicative of hydraulic fluid traveling into first cavity 30 thereby causing piston 20 to move to the right (FIG. 1) and a negative flow rate Q_{V1} can be indicative of hydraulic fluid traveling out of first cavity 30 thereby causing piston 20 to move to the left.

As a result, by measuring of the flow rate Q_{V1} of the hydraulic fluid flow traveling into and out of first cavity 30, piston information corresponding to the position, velocity, acceleration, and/or direction of movement of piston 20 of hydraulic actuator 12 can be determined. This piston information can provided to a user or additional processing electronics to assist in the control of an object being actuated by piston 20. Furthermore, the piston information can be used to control the position, velocity, acceleration, and/or direction of movement of piston 20 based upon a comparison to a desired position, velocity, acceleration, and/or direction of movement indicated by a reference signal.

In one preferred embodiment, flow sensor 44 is a differential pressure flow sensor. Here, flow sensor 44 is adapted to measure a pressure drop across a discontinuity placed in the hydraulic fluid flow and produce the sensor signal which relates to the pressure drop. The measured differential pressure can be used to calculate the flow rate Q_{V1} of the hydraulic fluid flow using known methods. Flow sensor 44 can include a bi-directional flow restriction member that produces the desired discontinuity in the hydraulic fluid flow and allows flow sensor 44 to calculate flow rates Q_{V1} of the hydraulic fluid flow flowing into and out of first cavity 30. One such suitable differential pressure flow sensor is described in U.S. patent application Ser. No. 09/521,537, entitled “BI-DIRECTIONAL DIFFERENTIAL PRESSURE FLOW SENSOR,” and assigned to the assignee of the present invention.

The sensor signal indicated by arrow 49, can be provided to controller 46 over communication link 48, as shown in FIG. 2. Controller 46 can then use the sensor signal 49 to calculate the piston information using the above-described equations. Alternatively, the sensor signal 49 produced by flow sensor 44 can relate directly to the piston information. Controller 46 is configured to produce a piston information signal (such as piston information output 58 or piston control signal 48).

Controller 46 can be any suitable device including hardware such as an embedded microcontroller, microprocessor, etc.; software; or combinations thereof. Controller 46 is further configured to produce a piston information output, indicated by arrow 58, relating to the piston information. The piston information output 58 can be provided to a human-machine interface 60, such as a display or graphical user interface, to provide the piston information to an operator of the machine to thereby aid in the control of the object being actuated by hydraulic actuator 12.

In another embodiment of the invention, controller 46 is adapted to receive a reference signal 64 from an input device 62, as shown in FIG. 2. Reference signal 64 generally relates to a position, velocity, acceleration and/or direction of movement of piston 12 that is desired by for example an operator of the machine. Input device 62 can be a steering device, a switch, a microcomputer, or other type of input device that could provide a reference signal 64. Controller 46 is adapted to compare the reference signal 64 to the sensor signal 68. This comparison provides controller 46 with information relating to an adjustment that must be made to the hydraulic fluid flow to reach the desired position, velocity, acceleration and/or direction of movement indicated by the reference signal 64. Controller 46 generates a control signal 66 that relates to the required adjustment of piston 12. The control signal 66 can be provided to a valve actuator 50 of hydraulic control valve 13 over communication link 52. Valve actuator 50 actuates hydraulic control valve 13 in response to control signal 66 to adjust the hydraulic fluid flow to produce the desired adjustment of the position, velocity, acceleration and/or direction of movement of piston 12. Those skilled in the art will recognize that controller 46 can be disposed at various locations. Moreover, controller 46 may be a stand-alone component or may be part of flow sensor 44 or even part of control valve 13.

Communication links 48 and 52 can be a physical communication link, such as wires or a data bus, or a wireless communication link. Communication links 48 and 52 can be configured in accordance with a standard 4-20 mA analog signal or a digital signal in accordance with a digital communication protocol such as FOUNDATION™ fieldbus, Controller Area Network (CAN), profibus, or a combination of analog and digital signals, such as with the Highway Addressable Remote Transducer (HART®). In addition, communication links 48 and 52 can provide power to flow sensor 44 and hydraulic control valve 13, respectively. Although FIG. 2 shows separate communication links 48 and 52 for each flow sensor 44A-C and hydraulic control valve 13A-C, a single data bus can be used to interconnect the multiple components of hydraulic control system 42.

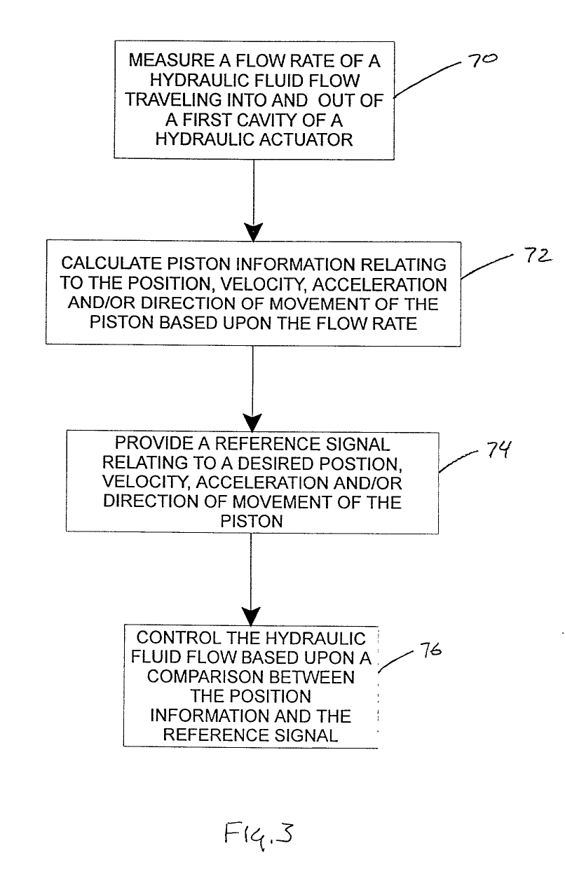

The present invention is also directed to a method of controlling at least one hydraulic actuator 12. The method is illustrated in the flowchart of FIG. 3. At step 70, a flow rate Qᵥ₁ of a hydraulic fluid flow traveling into and out of a first cavity 30 of the hydraulic actuator 12 is measured. Next, at step 72, piston information relating to the position, velocity, acceleration and/or direction of movement of piston 12 is calculated based upon the flow rate Qᵥ₁. At step 74, a reference signal 64 is provided that relates to a desired position, velocity, acceleration and/or direction of movement of piston 12. Finally, at step 76, the hydraulic fluid flow is adjusted based upon a comparison between the position information and the reference signal. This can be accomplished by providing a control signal to valve actuator 50, as discussed above.

Although the present invention has been described with reference to preferred embodiments, workers skilled in the art will recognize that changes may be made in form and detail without departing from the spirit and scope of the invention.

What is claimed is:

1. A hydraulic control system for use in a machine actuated by hydraulic actuators, the system comprising:
a fluid flow sensor disposed for measurement of a hydraulic fluid flow traveling into and out of a cavity of a hydraulic actuator and having a sensor signal that is related to piston information selected from a group consisting of at least one of a position, a velocity, an acceleration, and a direction of movement of a piston contained in a hydraulic cylinder of the hydraulic actuator;
a controller configured to receive the sensor signal and produce a piston information signal relating to the piston information; and
a communication link between the controller and the fluid flow sensor, whereby the sensor signal is provided to the controller.

2. The hydraulic control system of claim 1, wherein the communication link is selected from a group consisting of a physical communication link that provides power to the fluid flow sensor to completely power the sensor, and a wireless communication link.

3. The hydraulic control system of claim 1, wherein the communication link is selected from a group consisting of a two-wire (4-20) data bus, and a data bus.

4. The hydraulic control system of claim 1, wherein the communication link is configured in accordance with a communication standard selected from a group consisting of a digital communication standard, an analog communication standard, FOUNDATION™ fieldbus, Controller Area Network (CAN), profibus, and Highway Addressable Remote Transducer (HART®).

5. The hydraulic control system of claim 1, including a human-machine interface coupled to the controller and adapted to receive the piston information signal.

6. The hydraulic control system of claim 1, wherein the piston information signal comprises a control signal, which relates to a comparison of the sensor signal to a reference signal.

7. The hydraulic control system of claim 6, including a hydraulic control valve adapted to control the hydraulic fluid flow.

8. The hydraulic control system of claim 7, wherein:
the communication link further provides the control signal to the hydraulic control valve; and
the hydraulic control valve controls the hydraulic fluid flow in response to the control signal.

9. The hydraulic control system of claim 8, wherein the communication link is selected from a group consisting of a physical communication link, and a wireless communication link.

10. The hydraulic control system of claim 8, wherein the communication link is a data bus that is configured in accordance with a communication standard selected from a group consisting of a digital communication standard, an analog communication standard, FOUNDATION™ fieldbus, Controller Area Network (CAN), profibus, and Highway Addressable Remote Transducer (HART®).

11. The hydraulic control system of claim 1, wherein:
flow sensor is a differential pressure flow sensor; and
the sensor signal is based upon a differential pressure measured across a discontinuity in the hydraulic fluid flow.

12. A hydraulic control system for use in a machine actuated by hydraulic actuators, the system comprising:
a fluid flow sensor disposed for measurement of a hydraulic fluid flow traveling into and out of a cavity of a hydraulic actuator and having a sensor signal that is related to piston information selected from a group consisting of at least one of a position, a velocity, an acceleration, and a direction of movement of a piston contained in a hydraulic cylinder of the hydraulic actuator;
a reference signal relating to at least one of a desired piston position, velocity, acceleration, and direction of movement;
a controller configured to produce a control signal based upon a comparison of the sensor signal to the reference signal; and
a hydraulic control valve adapted to receive the control signal and adjust the hydraulic fluid flow in response thereto.

13. The hydraulic control system of claim 12, including:
a first communication link between the controller and the flow sensor; a
communication link between the controller and the hydraulic control valve;
wherein the first communication link provides the controller with the sensor signal, the second communication link provides the hydraulic control valve with the control signal, and the first and second communication links are selected from a group consisting of a physical link that is supplies power, a data bus, a two-wire data bus, and a wireless communication link.

14. The hydraulic control system of claim 12, wherein the communication link is configured in accordance with a communication standard selected from a group consisting of a digital communication standard, an analog communication standard, FOUNDATION™ fieldbus, Controller Area Network (CAN), profibus, and Highway Addressable Remote Transducer (HART®).

15. A hydraulic control system for use in a machine actuated by hydraulic actuators, the system comprising:
a plurality of fluid flow sensors disposed for measurement of hydraulic fluid flow traveling into and out of a cavity of each hydraulic actuator, each flow sensor providing a sensor signal that is related to piston information;
a controller configured to receive the sensor signals and produce a control signal based upon at least one of the sensor signals; and
at least one hydraulic control valve adapted to receive the control signal and adjust hydraulic fluid flow in response thereto.

16. A method of controlling at least one hydraulic actuator having a piston, comprising steps of:
measuring a flow rate of a hydraulic fluid flow traveling into and out of a cavity of the hydraulic actuator defined by the piston and a hydraulic cylinder;
calculating piston information selected from at least one of a position, a velocity, an acceleration, and a direction of movement of the piston, based upon the flow rate;
providing a reference signal relating to at least one of a desired position, velocity, acceleration, and direction of movement of the piston;
controlling the hydraulic fluid flow based upon a comparison between the piston information and the reference signal.

17. The method of claim 16, wherein the measuring step includes measuring differential pressure across a discontinuity placed in the hydraulic fluid flow.

18. The method of claim 16, wherein the controlling step includes:
generating a control signal based upon the comparison between the piston information and the reference signal; and
adjusting the hydraulic fluid flow in response to the control signal to provide desired actuation of the piston.
